(19) United States
(12) Patent Application Publication
(10) Pub. No.: US 2026/0079235 A1
(43) Pub. Date: Mar. 19, 2026

(54) CALIBRATION AND MONITORING IN CASCADED RADAR SYSTEM WITHOUT LOCAL OSCILLATOR SIGNAL DISTRIBUTION

(71) Applicant: Infineon Technologies AG, Neubiberg (DE)

(72) Inventors: Alexander Michael MELZER, Alberndorf in der Riedmark (AT); Michael GERSTMAIR, Langenstein (AT); Josef KULMER, Graz (AT)

(21) Appl. No.: 18/887,160

(22) Filed: Sep. 17, 2024

(51) Int. Cl. G01S 7/35; G01S 7/40; G01S 13/87

(52) U.S. Cl. CPC G01S 7/352; G01S 7/4008; G01S 7/4021; G01S 13/872

(57) ABSTRACT

A radar monolithic microwave integrated circuit (MMIC) includes a control logic configured to set the radar MMIC in one of a plurality of operation modes a local oscillator (LO) generation circuit configured to generate an LO signal; an LO output terminal configured to output the LO signal for LO distribution to another MMIC; and an LO distribution circuit coupled to the LO output terminal, and configured to receive the LO signal from the LO generation circuit and enable or disable the LO distribution of the LO signal based on a control signal. The control logic is configured to provide the control signal to the LO distribution circuit for enabling or disabling the LO distribution. The control signal is configured to enable the LO distribution circuit during a radar operation mode and disable the LO distribution circuit during at least one of a calibration operation mode or a monitoring operation mode.

### BACKGROUND

Radar sensors are used in a number of applications to detect objects, where the detection typically comprises measuring distances, velocities, or angles of arrival associated with detected targets. In particular, in the automotive sector, there is an increasing need for radar sensors that are able to be used in, for example, driving assistance systems (e.g., advanced driver assistance systems (ADAS)), such as for example in adaptive cruise control (ACC) or radar cruise control systems. Such systems are able to automatically adjust a speed of a motor vehicle in order to maintain a safe distance from other motor vehicles traveling in front of the motor vehicle (and from other objects and pedestrians). Other example applications of a radar sensor in the automotive sector include blind spot detection, lane change assist, and the like.

### SUMMARY

In some implementations, a radar monolithic microwave integrated circuit (MMIC) includes a control logic configured to set the radar MMIC in one of a plurality of operation modes, the plurality of operation modes including a radar operation mode, and at least one of a monitoring mode or a calibration mode; a system clock terminal configured to receive a system clock signal; a local oscillator (LO) generation circuit configured to generate an LO signal based on the system clock signal, wherein the LO generation circuit is configured to generate the LO signal as a frequency ramp signal during the radar operation mode; an LO output terminal configured to output the LO signal for LO distribution to another MMIC; and an LO distribution circuit coupled to the LO output terminal and configured to receive the LO signal from the LO generation circuit and enable or disable the LO distribution of the LO signal based on a first control signal indicating whether the LO distribution of the LO signal is enabled or disabled, wherein the control logic is configured to provide the first control signal to the LO distribution circuit for enabling or disabling the LO distribution, wherein the first control signal is configured to enable the LO distribution during the radar operation mode of the radar MMIC and disable the LO distribution during at least one of the calibration mode or the monitoring mode of the radar MMIC.

In some implementations, a radar MMIC includes a control logic configured to set the radar MMIC in a plurality of operation modes, including a radar operation mode and at least one of a monitoring mode or a calibration mode; an LO input terminal configured to receive a first LO signal from outside of the radar MMIC during a mode in which LO distribution of the first LO signal is enabled; a clock input terminal configured to receive a system clock signal during the plurality of operation modes; an LO generation circuit configured to generate a second LO signal based on the system clock signal; and an LO switching circuit configured to: receive the first LO signal from the LO input terminal, the second LO signal from the LO generation circuit, and a first control signal indicating whether the LO distribution of the first LO signal is enabled or disabled, output the first LO signal based on the first control signal indicating that the LO distribution of the first LO signal is enabled, and output the second LO signal based on the first control signal indicating that the LO distribution of the first LO signal is disabled, wherein the LO distribution of the first LO signal is enabled during the radar operation mode of the radar MMIC and disabled during at least one of the calibration mode or the monitoring mode of the radar MMIC.

In some implementations, a cascaded radar system includes a primary radar MMIC; and a secondary radar MMIC, wherein the primary radar MMIC comprises: a first control logic configured to set the radar MMIC in one of a first plurality of operation modes, the first plurality of operation modes including a first radar operation mode, and at least one of a first monitoring mode or a first calibration mode; a system clock terminal configured to receive a system clock signal; a first LO generation circuit configured to generate a first LO signal based on the system clock signal, wherein the first LO generation circuit is configured to generate the first LO signal as a first frequency ramp signal during the first radar operation mode; a clock output terminal configured to output the system clock signal for system clock distribution to the secondary MMIC; an LO output terminal configured to output the LO signal for LO distribution to the secondary MMIC; and an LO distribution circuit coupled to the LO output terminal and configured to receive the first LO signal from the first LO generation circuit and enable or disable the LO distribution of the first LO signal based on a first control signal indicating whether the LO distribution of the first LO signal is enabled or disabled, wherein the first control logic is configured to provide the first control signal to the LO distribution circuit for enabling or disabling the LO distribution, wherein the first control signal is configured to enable the LO distribution during the first radar operation mode of the primary radar MMIC and disable the LO distribution during at least one of the first calibration mode or the first monitoring mode of the primary radar MMIC.

In some implementations, a radar MMIC includes a control logic configured to set the radar MMIC in a plurality of operation modes, including a radar operation mode and at least one of a monitoring mode or a calibration mode; an LO input terminal configured to receive a first LO signal from outside of the radar MMIC during a mode in which LO distribution of the first LO signal is enabled; a clock input terminal configured to receive a system clock signal during the plurality of operation modes; an LO generation circuit configured to generate a second LO signal based on the system clock signal; an enabling-disabling circuit configured to receive a control signal indicating whether the LO distribution of the first LO signal is enabled or disabled, enable the second LO signal based on the control signal indicating that the LO distribution of the first LO signal is disabled, and disable the second LO signal based on the control signal indicating that the LO distribution of the first LO signal is enabled; and a combiner circuit configured to receive the first LO signal or the second LO signal based on the LO distribution being enabled or disabled, respectively; and a radar circuit coupled to the combiner circuit and configured to receive either the first LO signal or the second LO signal, wherein the LO distribution of the first LO signal is enabled during the radar operation mode of the radar MMIC and disabled during at least one of the calibration mode or the monitoring mode of the radar MMIC.

### BRIEF DESCRIPTION OF THE DRAWINGS

Implementations are described herein making reference to the appended drawings.

FIG. 1 is a diagram of an example application of a frequency-modulated continuous-wave (FMCW) radar sensor.

FIG. 2 illustrates an example of frequency modulation of a transmitted radar signal transmitted by the FMCW radar sensor.

FIG. 3 is a block diagram that illustrates an example structure of the FMCW radar sensor.

FIG. 4 illustrates an example implementation of the FMCW radar sensor according to the example from FIG. 3.

FIG. 5 is a block diagram for illustrating a cascaded radar system according to one or more implementations.

FIG. 6 illustrates a control circuit for a primary monolithic microwave integrated circuit (MMIC) according to one or more implementations.

FIG. 7 illustrates a control circuit for a secondary MMIC according to one or more implementations.

FIG. 8 illustrates a control circuit for a secondary MMIC according to one or more implementations.

FIG. 9 illustrates an example application cycle according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view rather than in detail in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A radar monolithic microwave integrated circuit (MMIC), sometimes referred to as single radar chip, may incorporate all core functions of a radio frequency (RF) frontend of a radar transceiver (e.g., local oscillator, power amplifiers, low-noise amplifiers (LNAs), mixers, etc.), analog preprocessing of the intermediate frequency (IF) or base band signals (e.g., filters, amplifiers, etc.), and analog-to-digital conversion in one single package. The RF frontend usually includes multiple reception (RX) and transmission (TX) channels, particularly in applications in which beam steering techniques, phased antenna arrays, etc. are used. In radar applications, phased antenna arrays may be employed to sense an incidence angle of incoming RF radar signals (also referred to as “direction of arrival” or DOA).

In the context of radar MMICs, so-called “cascaded systems” have emerged, whereby multiple MMICs are interconnected to embody a single overall system with increased resolution for radar target discrimination. In a multiple-input multiple-output (MIMO) system, a local oscillator source distributes an RF signal to the transmission and reception channels of each radar MMIC. Additionally, for advanced MIMO and reconfigurable radars it may be useful to have a high number of transmitter outputs on a radar chip, with each transmitter output coupled to a different antenna.

For some applications, the phase relationship between channels, both from an inter-chip and intra-chip perspective, is important. A phase difference between transmission channels can drift or become unbalanced, for example, due to temperature changes. This parameter is called “phase drift,” and ensuring low phase drift can be technically challenging. Transmission signal monitoring can be used to measure the phase of each inter-chip and/or intra-chip TX channel, and phase shifters can be used to calibrate each transmission channel based on the result to minimize the phase drift (so called phase balancing).

Additionally, reception signal monitoring is an operation that may be executed by a radar MMIC to ensure that all units involved in reception of a radar signal are working as expected and the received radar data can be trusted for use. In particular, a monitoring subsystem can be used to observe key parameters and performance or health indicators, by means of specific measurements carried out on special test signals, which can highlight faults in the system so that appropriate action can be taken in such occurrences. One common circumstance in which the monitoring subsystem can become ineffective is the presence of interference during the monitoring measurement (e.g., during injection of the monitoring signal or test signal into an RX channel). In such cases, interference may impact the result of the monitoring and be treated as a fault. This may result in part of or the entire system being shut down, despite the possible interference being only a temporary event.

Additionally, electromagnetic compatibility (EMC) performance is a crucial criterion for radar system designs and is subject to various regulatory limits. To a large extent, the various regulatory limits placed on EMC performance are non-standardized across countries and continents. With high resolution radar systems, including cascaded systems, the fulfillment of the various regulatory limits becomes more challenging as more radar channels have to be operated at the same time. The higher radar channel count inevitably yields higher unwanted electromagnetic emissions. These electromagnetic emissions can be reduced to some extend by shielding a radar module, but at increased overall costs. To meet the various regulatory limits and to save costs, it is preferrable to minimize unwanted electromagnetic emissions as much as possible in current radar MMIC and printed circuit board (PCB) designs (e.g., in current hardware designs).

A cascaded radar system may include a primary radar MMIC and one or more secondary radar MMICs configured in a primary/secondary relationship. Each radar MMIC, including the primary MMIC and the one or more secondary radar MMICs, may have a same physical structure (e.g., same circuitry), but one radar MMIC may be configured to operate as the primary radar MMIC, while the remaining radar MMICs may be configured to operate as secondary radar MMICs. The primary radar MMIC may distribute system clock and LO signals, typically routed on a PCB, to the one or more secondary radar MMICs. The system clock and LO signals may be used by the one or more secondary radar MMICs to perform one or more operations. The primary radar MMIC may also distribute the system clock and LO signals back to itself in order to ensure each radar MMIC is operated in phase or in synchronization with each other. While each radar MMIC includes its own LO generation circuit (e.g., its own local oscillator), using a distributed LO signal amongst all radar MMICs may enable a coherent radar operation for increased resolution for radar target discrimination. However, a distribution of the LO signals, for example, during all operation modes, may increase unwanted electromagnetic emissions.

Some implementations disclosed herein are directed to a radar system, such as a cascaded radar system, that includes a primary radar MMIC that is configured to regulate a distribution of the LO signal based on an operation mode in which the primary radar MMIC and/or one or more secondary radar MMICs are operating. The primary radar MMIC may enable the distribution of the LO signal for certain operation modes and disable the distribution of the LO signal for other operation modes. For example, the primary radar MMIC may enable the distribution of the LO signal during a radar operation mode, during which radar signals are transmitted, and may disable the distribution of the LO signal during at least one of a monitoring mode or a calibration mode, during which radar signals are not transmitted.

While the distribution of the LO signal is enabled, each radar MMIC, including the primary MMIC and the one or more secondary radar MMICs may use the LO signal for performing a coherent radar operation. For example, each radar MMIC may use the LO signal for generating radar signals for transmission and for processing reception radar signals or radar echoes (e.g., for demodulating of radar echoes).

While the distribution of the LO signal is disabled (e.g., during the monitoring mode or the calibration mode), each secondary radar MMIC may use its own LO generation circuit to generate a respective LO signal. Thus, the respective LO signal may be generated and used internally at each secondary radar MMIC. The respective LO signal may be used by a corresponding secondary radar MMIC for performing a monitoring operation (e.g., during monitoring mode) and/or a calibration operation (e.g., during calibration mode) within the corresponding secondary radar MMIC.

In this way, an amount of time the LO signal is distributed from the primary radar MMIC to the one or more secondary radar MMICs can be reduced, which may result in lower electromagnetic emissions. The lower electromagnetic emissions may enable additional secondary radar MMICs to be added to the radar system and/or additional radar channels to be added to existing radar MMICs while meeting the various regulatory limits. Thus, the resolution of the radar system may be maintained or increased while meeting the various regulatory limits for electromagnetic emissions.

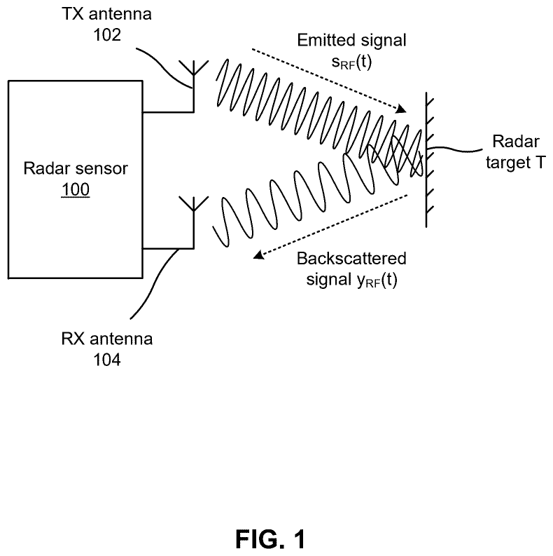

FIG. 1 is a diagram illustrating an example application of a frequency-modulated continuous-wave (FMCW) radar sensor in the form of a radar sensor 100 for measuring distances, velocities, or angle of arrivals (AoAs) associated with objects, referred to as targets. As shown in FIG. 1, the radar sensor 100 may have one or more TX antennas 102 and one or more RX antennas 104. In some implementations, a single antenna may be used that serves simultaneously as a TX antenna 102 and as an RX antenna 104.

In operation, the TX antenna 102 continuously emits an RF signal s_{RF}(t) (also referred to as a transmitted radar signal), which is frequency-modulated, for example, by a periodic linear frequency ramp signal (also referred to as a frequency sweep or chirp signal). The transmitted radar signal s_{RF}(t) is backscattered at a target T and a reflected signal y_{RF}(t) (e.g., a back-scattered signal, an echo signal, a received RF signal, or a received radar signal) is received by the RX antenna 104. FIG. 1 shows a simplified example—in practice, the radar sensor 100 may include a plurality of TX antennas 102 and RX antennas 104 to be able to determine an AoA of the received RF signal y_{RF}(t) and, therefore, locate the target T with increased accuracy compared to a radar sensor that may use a single TX antenna and/or a signal RX antenna.

It will be appreciated that “(t)” denotes an analog signal defined as a continuous-time signal that may change over a time period t, and “[n]” denotes a digital signal defined as a discrete-time signal, where n is an integer and may represent an nth sample or a signal containing n samples. A signal may be represented with or without its continuous-time or discrete-time domain identifier (t) and [n], respectively. It will be further appreciated that RF circuits, such as the radar sensor 100, may be used in fields other than radar. For example, RF circuits may be used in RF communication systems. Accordingly, in some implementations, the radar sensor 100 may be used in RF applications other than radar, such as RF communications.

As indicated above, FIG. 1 is provided as an example. Other examples may differ from what is described with regard to FIG. 1.

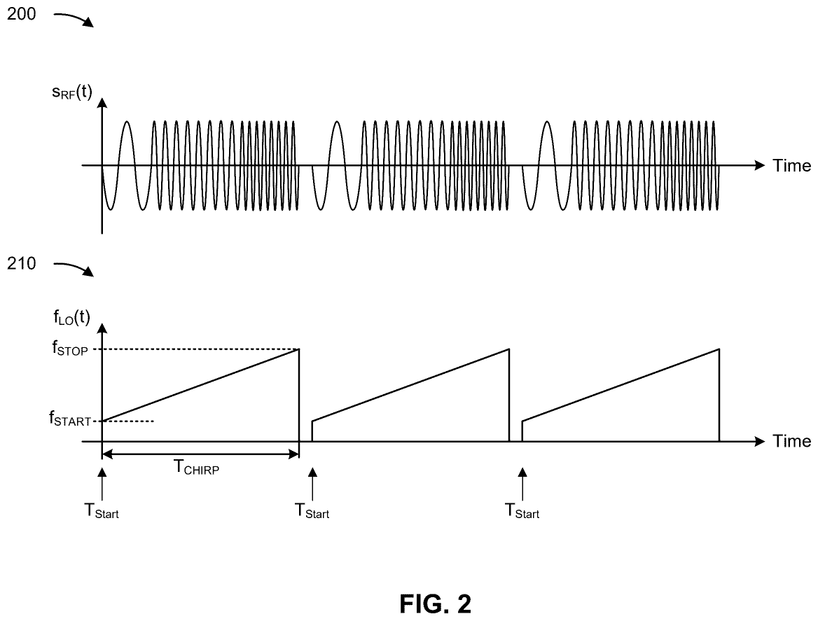

FIG. 2 illustrates an example of the frequency modulation of the RF signal s_{RF}(t). As illustrated in the upper diagram 200 of FIG. 2, the RF signal s_{RF}(t) comprises a plurality of frequency ramps or series of “chirps”; that is to say, the RF signal s_{RF}(t) comprises a sequence of sinusoidal signal profiles (e.g., waveforms) with a rising frequency (referred to as an up-chirp) or a falling frequency (referred to as a down-chirp). In the example shown in FIG. 2, the instantaneous frequency f_{LO}(t) of a chirp increases linearly, starting at a start frequency f_{START}, to a stop frequency f_{STOP} within a time interval T_{CHIRP}, as shown in the lower diagram 210 of FIG. 2. Such chirps are also referred to as linear frequency ramps. For a measurement, a sequence of frequency ramps is emitted, and a resulting echo signal is evaluated in baseband to detect one or more radar targets.

A frequency-modulated ramp signal, such as a local oscillator signal used for generating a radar signal, may include a plurality of radar frames, which may also be referred to as radar operation cycles or chirp frames. A sequence of ramps may make up each radar frame. For example, a radar operation cycle may include several hundreds of radar ramps (sweeps) taking up to 10-30 milliseconds (ms) in total. A frame length of the radar frame may correspond to one radar operation cycle. Consecutive ramps may have a short pause therebetween, and a longer pause may be used between consecutive radar frames. The longer pause between consecutive radar frames may be referred to as a configuration interval, during which one or more ramp parameters of the RF signal s_{RF}(t) can be adjusted for subsequent radar frames. A ramp start time T_{START} indicates a start time for each chirp and may occur at a predetermined interval according to, for example, a number of clock cycles.

The start frequency f_{START} and stop frequency f_{STOP} of the ramps may be within a frequency band with minimum frequency Fmin and maximum frequency Fmax. As a result, the minimum frequency Fmin and the maximum frequency Fmax define an operating frequency range or a frequency band usable for the ramping signals, and thus the frequency range or the frequency band of the radar application of a radar MMIC. In some implementations, the frequency range defined by a single ramp having start and stop frequencies f_{START} and f_{STOP} may be smaller than the usable radar frequency band. However, all ramps that are generated during operation may lie between the frequencies Fmin and Fmax of the radar frequency band (e.g., between 76-81 GHz) used for generating the ramping signals.

FIG. 2 illustrates three identical linear frequency ramps or chirps. However, the parameters f_{START}, f_{STOP}, T_{CHIRP}, and/or the pause between the individual frequency ramps may vary dependent on the actual implementation and use of the radar sensor 100. In practice, the frequency variation may be, for example, linear (linear ramp, frequency ramp), exponential (exponential ramp), or hyperbolic (hyperbolic ramp). In some implementations, the frequency may decrease instead of increase during time interval T_{CHIRP}. Furthermore, in some implementations, a center frequency of each ramp (and therefore f_{START} and f_{STOP}) may vary (e.g., from ramp to ramp or after detecting an interference) to allow using the full or a part of the frequency band. In one example, the frequency band has a minimum frequency Fmin of 76 gigahertz (GHz) and a maximum frequency Fmax of 81 GHz.

Thus, while three identical linear frequency ramps or chirps with the same start frequency f_{START} and stop frequency f_{STOP} are illustrated in FIG. 2, it is contemplated that the start frequency f_{START} and stop frequency f_{STOP} may vary within a radar frame or across multiple radar frames. A local oscillator signal S_{LO}(t) may be used to generate the RF signal S_{RF}(t). Thus, it can be said that the local oscillator signal S_{LO}(t) and the RF signal SRF(t) are frequency-modulated ramp signals that are generated within an operating frequency range (e.g., a predefined radar frequency range). For example, the local oscillator signal S_{LO}(t) may be a frequency-modulated ramp signal that includes a plurality of frequency ramps, each starting at a respective ramp start frequency and ending at a respective ramp stop frequency, and the respective ramp start frequencies and the respective ramp stop frequencies of the plurality of frequency ramps define a frequency range within the bounds of the operating frequency range. The frequency range of the plurality of frequency ramps may be defined by the lowest start frequency f_{START} and the highest stop frequency f_{STOP} among the frequency ramps in a given time interval (e.g., in an implementation in which the frequency increases within each frequency ramp). As noted above, the start frequency f_{START} and the stop frequency f_{STOP} of a sequence of frequency ramps may be the same, and thus the center frequency of each ramp may be constant. Alternatively, the center frequency of each ramp (and therefore f_{START} and f_{STOP}) may vary from ramp to ramp or after detecting an interference. The bandwidth (e.g., frequency range) of each ramp may also vary from ramp to ramp or after detecting an interference.

As indicated above, FIG. 2 is provided as an example. Other examples may differ from what is described with regard to FIG. 2.

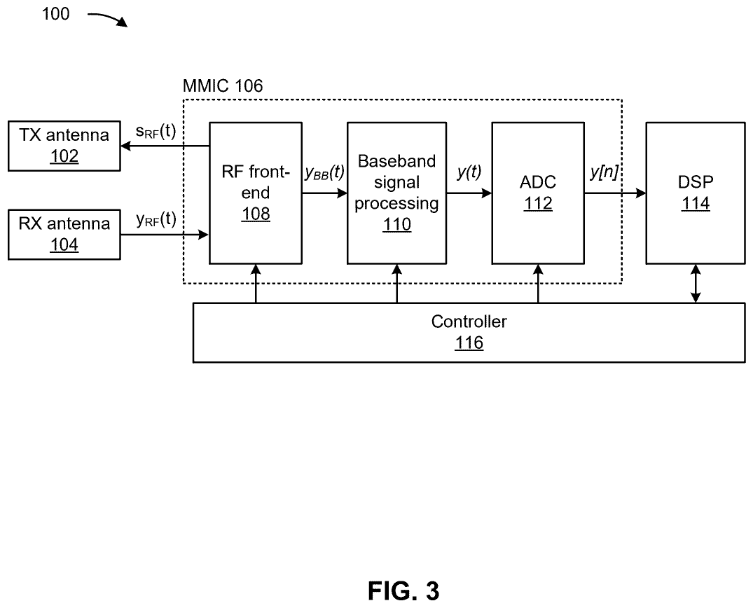

FIG. 3 is a block diagram that illustrates an example structure of the radar sensor 100. As shown, the radar sensor 100 may include one or more TX antennas 102, one or more RX antennas 104, an MMIC 106 (comprising an RF front-end 108, a baseband signal processing circuit 110, and an analog-to-digital convertor (ADC) 112), a digital signal processor (DSP) 114, and a controller 116. The MMIC 106 may be a primary radar MMIC or a secondary radar MMIC. In some implementations, the MMIC 106 may include a digital front-end (DFE) coupled downstream from the ADC 112. The digital front-end may include circuit components associated with performing signal processing on a digital signal generated by the ADC 112 (e.g., digital filtering). In some cases, the DFE may include the DSP 114. In some implementations, the MMIC 106 may include a control logic configured to set the MMIC 106 in one of a plurality of operation modes. The plurality of operation modes may include a radar operation mode, and at least one of a monitoring mode or a calibration mode.

In the radar sensor 100, the one or more TX antennas 102 and the one or more RX antennas 104 are connected to the RF front-end 108. The RF front-end 108 may include circuit components associated with performing RF signal processing. These circuit components may include, for example, a local oscillator (LO), one or more RF power amplifiers, one or more LNAs, one or more directional couplers (e.g., rat-race couplers, circulators, or the like), or one or more mixers for downmixing (e.g., down-converting or demodulating) RF signals into baseband or an IF band. The RF front-end 108 may be integrated into the MMIC 106 with one or more other components, as shown in FIG. 3. The IF band is sometimes also referred to as baseband. Accordingly, “baseband” and “IF band” may be used interchangeably herein. Baseband signals are those signals on the basis of which radar targets are detected.

Antenna-arrays may be used instead of single antennas. The depicted example shows a bistatic radar system a pseudo-monostatic radar system, which has separate RX and TX antennas. In the case of a monostatic radar system, a single antenna or a single antenna array may be used to both receive and transmit electromagnetic (radar) signals. In this case, a directional coupler (e.g., a circulator) may be used to separate RF signals to be transmitted to the radar channel from RF signals received from the radar channel. In practice, radar systems often include several TX and RX channels, which allows the measurement of the direction (e.g., direction of arrival) from which the radar echoes are received.

In some implementations, the radar sensor 100 may include a plurality of TX antennas 102 and a plurality of RX antennas 104, which enables the radar sensor 100 to measure an AoA from which radar echoes are received. In the case of such MIMO systems, individual TX channels and RX channels may be constructed identically or similarly and may be distributed over one or more MMICs 106.

In some implementations, a signal emitted by the TX antenna 102 may be in a range from approximately 20 GHz to approximately 100 GHz, such as in a range between approximately 76 GHz and approximately 81 GHz. As mentioned, a radar signal received by the RX antenna 104 includes radar echoes (e.g., chirp echo signals); that is to say, those signal components that are backscattered at one or more targets.

The received RF signal y_{RF}(t) is downmixed into, for example, baseband to generate a baseband signal y_{BB}(t), and the baseband signal y_{BB}(t) is processed further in baseband by way of analog signal processing performed by the baseband signal processing circuit 110. In some implementations, the baseband signal processing circuit 110 may be configured to filter and/or amplify the baseband signal y_{BB}(t) to generate an analog (baseband) output signal y(t) that is derived from the baseband signal y_{BB}(t). The baseband signal y_{BB}(t) may also be referred to as analog radar data. If the received RF signals are down-converted into the IF band, the baseband signal processing circuit 110 may be referred to as an IF signal processing circuit. Thus, the baseband signal processing circuit 110, in general, may also be referred to as an analog signal processing circuit.

The ADC 112 may be configured to digitize the baseband signal y_{BB}(t) or the analog output signal y(t) to generate a digital baseband signal y[n], also referred to as a digital output signal. The digital baseband signal y[n] is representative of the radar data received in the received RF signal y_{RF}(t). The DSP 114 may be configured to further process the digital baseband signal y[n] in the digital domain. For example, the DSP 114 may be configured to receive the digital radar data in the digital baseband signal y[n] and process the digital radar data using the ramp parameters (e.g., respective ramp start frequencies, the respective ramp stop frequencies, a bandwidth of a frequency range, a ramp start time, or a sampling start time) used to generate the respective frequency ramps of the received RF signal y_{RF}(t) in order to generate a range Doppler map, which may then be further used by the DSP 114 for object detection, classification, and so on.

In some implementations, the controller 116 is configured to control operation of the radar sensor 100 (e.g., by controlling one or more other components of the radar sensor 100, as indicated in FIG. 3). The controller 116 may include, for example, a microcontroller (μC). The controller 116 may configure the control logic to switch the MMIC 106 between the plurality of operation modes according to an operation mode sequence.

In some implementations, the RF front-end 108, the baseband signal processing circuit 110, the ADC 112, and/or the DSP 114 may be integrated in a single MMIC 106 (e.g., an RF semiconductor chip). Alternatively, two or more of these components may be distributed over multiple MMICs 106. In some implementations, the DSP 114 may be included in the controller 116. In some implementations, the techniques associated with TX monitoring and/or RX monitoring may be performed by one or more components of the radar sensor 100, such as by the DSP 114, the controller 116, or the like.

As indicated above, FIG. 3 is provided as an example. Other examples may differ from what is described with regard to FIG. 3. The number and arrangement of devices and components shown in FIG. 3 are provided as an example. In practice, there may be additional devices or components, fewer devices or components, different devices or components, or differently arranged devices or components than those shown in FIG. 3. Furthermore, two or more devices or components shown in FIG. 3 may be implemented within a single device or component, or a single device or component shown in FIG. 3 may be implemented as multiple, distributed devices or components. Additionally, or alternatively, a set of devices or components (e.g., one or more devices or components) shown in FIG. 3 may perform one or more functions described as being performed by another set of devices or components shown in FIG. 3.

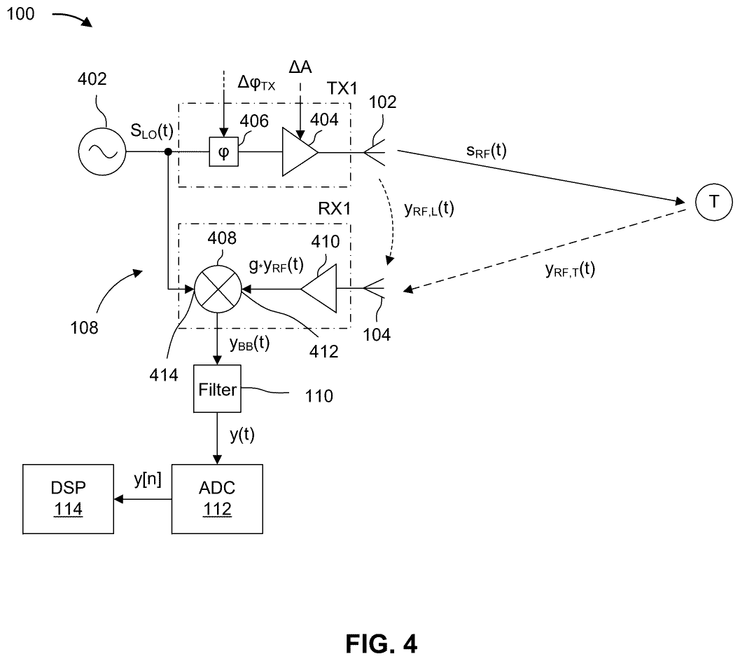

FIG. 4 illustrates an example implementation of the radar sensor 100 according to the example from FIG. 3. The example shown in FIG. 4 illustrates an example of the RF front-end 108 of the radar sensor 100. FIG. 4 illustrates a simplified circuit diagram to show a fundamental structure of the RF front-end 108 with one TX channel TX1 and one RX channel RX1. As noted above, the radar sensor 100 may in practice include a plurality of TX channels and/or a plurality of RX channels.

The RF front-end 108 comprises an local oscillator 402 (e.g., an LO generation circuit) that generates an RF oscillator signal S_{LO}(t). The local oscillator 402 may be a phase-locked loop (PLL), such as a digital PLL, that generates the RF oscillator signal S_{LO}(t) that includes a plurality of signal sequences. The local oscillator 402 may be part of a millimeter-wave signal generator. The RF oscillator signal S_{LO}(t) may be frequency-modulated during a radar operation (e.g., as described above with reference to FIG. 2) and may also be referred to as an LO signal, an input RF signal, or a reference signal. In radar applications, the LO signal may be in a super high frequency (SHF) band (e.g., centimeter wave) or in an extremely high frequency (EHF) band (e.g., millimeter wave), for example, in a range between approximately 76 GHz and approximately 81 GHz. In some radar applications, the LO signal may be in a 24 GHz industrial, scientific, and medical (ISM) band. The LO signal may also be generated at a lower frequency and then up-converted using frequency multiplication units. The LO signal s_{LO}(t) is processed both in the transmitted radar signal path TX1 (in the TX channel) and in the received RF signal path RX1 (in the RX channel). The local oscillator 402 may generate the LO signal as a frequency ramp signal during the radar operation mode, and may generate the LO signal as a single frequency signal during the calibration mode and the monitoring mode of the MMIC 106.

While the local oscillator 402 may be provided on a chip, the local oscillator 402 may also be provided external thereto. For example, the LO signal may be provided by an external local oscillator, and/or the LO signal may be provided to the MMIC 106 by another MMIC in a primary/secondary relationship. In particular, the MMIC 106 may be part of a MIMO radar system comprising a plurality of coupled (cascaded) MMICs in which one of the MMIC is configured as a primary MMIC and the remaining MMICs are configured as secondary MMICs. Each of the MMICs may include a local oscillator that generates a respective RF oscillator signal S_{LO}(t). However, for the operation of the MIMO radar system, it may be beneficial for LO signals used by the MMICs to be coherent. Therefore, the LO signal may be generated in one MMIC (e.g., the primary MMIC), and a representation of the LO signal may be distributed to the secondary MMICs. The representation may, for example, be identical to the LO signal, or the representation may be a frequency-divided signal which is then reconstructed at each MMIC by frequency multiplication. While in the following description, a distribution of the LO signal will be described, the following description may also be applied to a frequency-divided distribution of the LO signal. In some implementations, the primary MMIC may also use the LO signal to feed itself via a signal loop to ensure that the LO signal is equally delayed between the primary MMIC and the secondary MMICs.

The RF oscillator signal S_{LO}(t) is processed both in the transmission signal path TX1 (in the TX channel) and in the received signal path RX1 (in the RX channel). The RF signal S_{RF}(t) (i.e., the outgoing radar signal) transmitted by the TX antenna 102 may be generated by amplifying the RF oscillator signal S_{LO}(t), for example by an RF power amplifier 404, and may therefore be an amplified and possibly phase-shifted (e.g., by a phase shifter 406) version of the RF oscillator signal S_{LO}(t). The transmission channel may also include a phase shifter 406 for applying a programmable phase shift p to the RF oscillator signal S_{LO}(t). For example, the phase shifter 406 may be configurable by a phase control signal Δφ_{TX} and may be used to manipulate the overall phase lag caused by the transmission channel TX1. The magnitude or power level (e.g., gain) of the RF power amplifier 404 may also be programmable and adjustable by a gain control signal ΔA.

Both the phase control signal Δφ_{TX} and the gain control signal ΔA may be set and adjusted by a controller of the radar sensor 100 (e.g., controller 116). For example, by setting the power level of the RF power amplifier 404, the transmit power of the transmission channel TX1 may be set to a transmission power while the local oscillator 402 generates the RF oscillator signal S_{LO}(t) with the frequency ramps intended to be transmitted as the RF signal S_{RF}(t) (e.g., the transmission signal) and received as the received RF signal y_{RF}(t) for the processing of radar data. The output of the RF power amplifier 404 can be coupled to the TX antenna 102 (in the case of a bistatic/pseudo-monostatic radar configuration). In some cases, the power level of the RF power amplifier 404 may be set to zero to disable the transmission channel TX1 (e.g., to disable a transmission of the RF signal S_{RF}(t)). In other words, while the power level of the RF power amplifier 404 is set to zero, the output power of the RF power amplifier 404 is zero and no signal is provided to the TX antenna 102.

The RX channel RX1 includes a mixer 408 and an optional amplifier 410. The received RF signal y_{RF}(t) received by the RX antenna 104 is supplied to a receiver circuit in the RX channel RX1 and hence directly or indirectly to an RF port 412 of the mixer 408. In the present example, the received RF signal y_{RF}(t) (antenna signal) is pre-amplified by the amplifier 410 with a gain g. The mixer 408 thus receives the amplified received RF signal g·y_{RF}(t). The amplifier 410 can be, for example, a low-noise amplifier.

The mixer 408 further includes a reference port 414 that may be supplied with the RF oscillator signal S_{LO}(t) so that the mixer 408 down-converts the (pre-amplified) received RF signal y_{RF}(t) to the baseband (or the IF band). The down-converted baseband signal (mixer output signal) is denoted by y_{BB}(t). This baseband signal y_{BB}(t) is processed further in the analog domain by the baseband signal processing circuit 110, substantially causing an amplification and a filtering (e.g., bandpass filtering, low-pass filtering, and/or high-pass filtering) in order to, for example, reject undesirable sidebands and/or mirror frequencies. The resulting analog output signal is denoted by y(t) and is supplied to the ADC 112. The ADC 112 is configured to convert the analog output signal y(t) into the digital baseband signal y[n] (e.g., the digital output signal) that undergoes further digital post-processing via a signal processor (e.g., the DSP 114). Further digital processing of the digital baseband signal y[n] may include, for example, range Doppler analysis.

In the present example, the mixer 408 may down-convert the pre-amplified received RF signal g·y_{RF}(t) (e.g., the amplified antenna signal) into baseband. In some implementations, the mixing may be performed in one stage (e.g., from the RF band directly into baseband) or over one or more intermediate stages (e.g., from the RF band into an intermediate frequency band, and further into baseband). In the latter case, the mixer 408 may comprise a plurality of individual mixer stages connected in series. In some implementations, a mixer stage may include an in-phase and quadrature (IQ) mixer that generates two baseband signals (in-phase and quadrature signals) that can be interpreted as a real part and an imaginary part of a complex baseband signal. In other words, the IQ mixer may be used to generate complex baseband signals (e.g., including in-phase and quadrature components).

As depicted in FIG. 4, the RX antenna 104 of the RX channel RX1 may receive a superimposition comprising a received RF signal y_{RF,T}(t) reflected from the target T and a direct crosstalk from the transmitting antenna 102, which is also referred to as leakage signal y_{RF,L}(t). Reflections from an object situated right in front of the antennas (sometimes also called “blockers”) are also referred to as crosstalk here, and may contribute to the leakage signal. Both signals y_{RF,T}(t) and y_{RF,L}(t) are substantially delayed and attenuated versions of the RF signal S_{RF}(t) of the transmission channel TX1. A time delay between the RF signal S_{R}t) of the transmission channel TX1 and the received leakage signal y_{RF,L}(t) (e.g., the crosstalk signal) is relatively short in comparison with a time delay of the received RF signal y_{RF,T}(t) received from the target T. In a normal radar mode, the received leakage signal y_{RF,L}(t) may therefore cause a corresponding low-frequency component in the baseband signal y_{BB}(t), and this low-frequency component of the baseband signal y_{BB}(t) may be rejected in the baseband signal processing circuit 110. For this purpose, the baseband signal processing circuit 110 may include a bandpass filter, a low-pass filter, and/or a high-pass filter having a suitable cut-off frequency.

As indicated above, FIG. 4 is provided as an example. Other examples may differ from what is described with regard to FIG. 4. The number and arrangement of devices and components shown in FIG. 4 are provided as an example. In practice, there may be additional devices or components, fewer devices or components, different devices or components, or differently arranged devices or components than those shown in FIG. 4. Furthermore, two or more devices or components shown in FIG. 4 may be implemented within a single device or component, or a single device or component shown in FIG. 4 may be implemented as multiple, distributed devices or components. Additionally, or alternatively, a set of devices or components (e.g., one or more devices or components) shown in FIG. 4 may perform one or more functions described as being performed by another set of devices or components shown in FIG. 4.

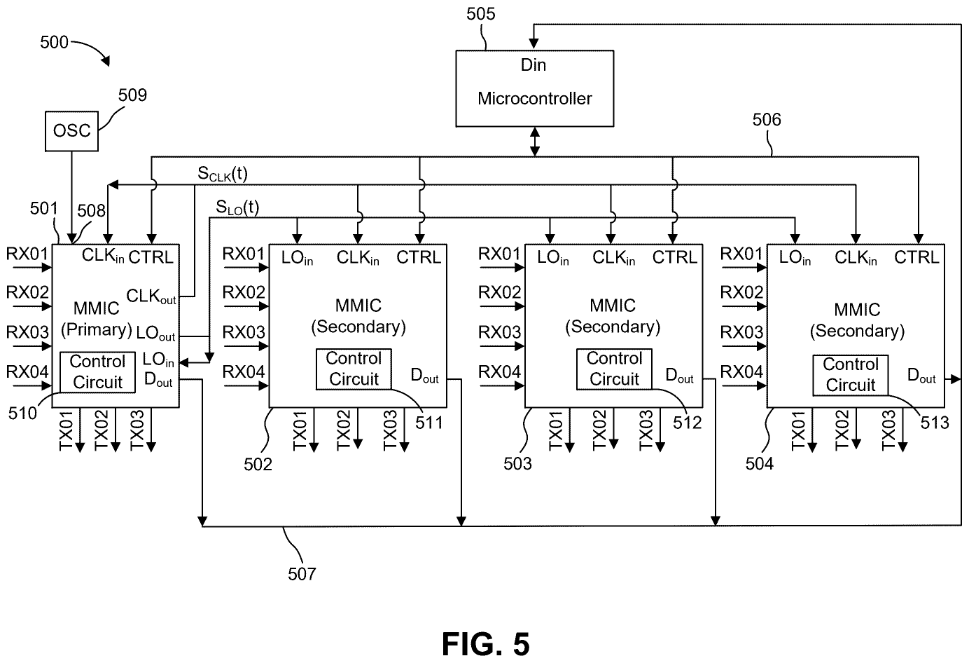

FIG. 5 is a block diagram for illustrating a cascaded radar system 500 comprising a controller and a plurality of cascaded MMICs according to one or more implementations. In particular, the cascaded radar system 500 is a MIMO radar system comprising a plurality of coupled (cascaded) MMICs 501, 502, 503, and 504 that are further coupled to a microcontroller 505. The microcontroller 505 may implement some of the functionality of the controller 116 described in connection with FIG. 3. While the microcontroller 505 is shown external to the MMICs 501-504, the microcontroller 505 may be integrated within one of the MMICs 501-504 while performing the same functions described herein. In addition, the MMIC 501 may be configured as a primary MMIC and the MMICs 502, 503, and 504 may be configured as secondary MMICs. For example, a secondary MMIC may use one or more signals and/or information provided by the primary MMIC to perform one or more functions.

Each MMIC 501, 502, 503, and 504 can comprise a plurality of transmitting channels TX01, TX02, TX03 and a plurality of receiving channels RX01, RX02, RX03, RX04. Each of the transmitting channels may be coupled to a respective transmit antenna for transmitting radar signals and each of the receiving channels may be coupled to a respective receive antenna for receiving (reflected) radar signals. However, as noted above, it is also possible that an MMIC only includes a receiver with no transmitter or a transmitter with no receiver. Thus, in some cases, an MMIC may not include any transmitting channels or may not include any receiving channels.

Each of the MMICs 501-504 may include an RF front-end 108, a baseband signal processing circuit 110, and an ADC 112, as described in connection with FIGS. 3 and 4. Thus, each of the MMICs 501-504 may include a local oscillator (e.g., local oscillator 402) that generates an RF oscillator signal S_{LO}(t) (e.g., an LO signal). However, for the operation of the cascaded radar system 500, it may be beneficial for the LO signals used by the MMICs 501-504 to be coherent. Therefore, the RF oscillator signal S_{LO}(t) may be generated in one MMIC (e.g., MMIC 501 as the primary MMIC) and distribute a representation of the RF oscillator signal S_{LO}(t) to the secondary MMICs 502, 503, and 504. For example, the representation of the RF oscillator signal S_{LO}(t) may be identical to the RF oscillator signal S_{LO}(t), or the representation of the RF oscillator signal S_{LO}(t) may be a frequency-divided signal which is then reconstructed at each secondary MMIC by frequency multiplication.

While in the following a distribution of the RF oscillator signal S_{LO}(t) will be described, a frequency-divided distribution of the RF oscillator signal S_{LO}(t) may also be used in some implementations. In the example illustrated, for this purpose, the RF oscillator signal S_{LO}(t) is passed from an LO output LOₒᵤₜ (e.g., an LO output terminal) of the primary MMIC 501 to LO inputs LOᵢₙ (e.g., LO input terminals) of respective secondary MMICs 502, 503, and 504. In some implementations, a unidirectional power splitter may first receive the RF oscillator signal Sit) from the primary MMIC 501, and distribute the split signal to the LO inputs LOᵢₙ of the secondary MMICs 502, 503, and 504. In some implementations, an LO output LOₒᵤₜ (e.g., an LO input terminal) of the primary MMIC 501 may be coupled to the LO input LOᵢₙ of the primary MMIC 501 such that the primary MMIC 501 can feed itself the RF oscillator signal S_{LO}(t) to make sure the RF oscillator signal S_{LO}(t) is equally delayed between the primary MMIC 501 and the secondary MMICs 502, 503, and 504.

The LO output LOₒᵤₜ and the LO inputs LOᵢₙ can be realized as a pin, a solder ball, or the like, depending on the chip package of the MMIC. In some example implementations, the LO output LOₒᵤₜ and/or the LO inputs LOᵢₙ can be realized by dedicated external contacts (e.g., pin, solder ball, etc.).

In the example illustrated in FIG. 5, the outputs designated by TX01, TX02, and TX03 can be connected to (transmitting) antennas, and the inputs designated by RX01, RX02, RX03 and RX04 can be connected to (receiving) antennas. All of the MMICs 501-504 can each comprise a local oscillator (e.g., local oscillator 402), but the local oscillators may not be used in some operating modes in the MMICs 502-504 that are configured as secondary MMICs. For normal radar operation, the RF oscillator signal S_{LO}(t) may be generated centrally in the primary MMIC 501 and distributed to the secondary MMICs 502-504. As a result, the RF oscillator signals S_{LO}(t) processed in the MMICs 501-504 are coherent. Thus, the LO output LOₒᵤₜ (e.g., an LO output terminal) of the primary MMIC 501 may be configured to output the RF oscillator signal S_{LO}(t) for LO distribution to the secondary MMICs 502-504. Put another way, the primary MMIC 501 may generate the RF oscillator signal S_{LO}(t) and distribute the RF oscillator signal S_{LO}(t) via the LO output of the primary MMIC 501 to the secondary MMICs 502, 503, and 504. As a result, the MMICs 501-504 can be connected in a cascaded configuration.

A clock signal S_{CLK}(t) (e.g., a system clock signal) can likewise be distributed by the primary MMIC 501 to the secondary MMICs 502, 503, and 504. The primary MMIC 501 may generate the clock signal S_{CLK}(t) from a reference clock signal received from a separate reference clock generator, such as a quartz oscillator. For example, in some implementations, the primary MMIC 501 may include a system clock terminal 508 configured to receive the reference clock signal from an external crystal oscillator circuit 509, such as a quartz oscillator. In some implementations, the reference clock signal may be used as the clock signal S_{CLK}(t) and may be distributed by the primary MMIC 501 to the secondary MMICs 502-504 as the system clock signal. For this purpose, the MMICs 501, 502, 503, and 504 may each have a clock output CLKout (e.g., clock output terminal) and/or a clock input CLKin (e.g., clock input terminal), which can be connected by means of strip lines. The clock output CLKout of the primary MMIC 501 may be configured to output the clock signal S_{CLK}(t) for system clock distribution to the secondary MMICs 502-504. In some implementations, the clock output CLKout of the primary MMIC 501 may be coupled to the clock input CLKin of the primary MMIC 501 such that the primary MMIC 501 can feed itself the clock signal S_{CLK}(t) to make sure the clock signal S_{CLK}(t) is equally delayed between the primary MMIC 501 and the secondary MMICs 502, 503, and 504.

The primary MMIC 501 may generate the RF oscillator signal S_{LO}(t) based on the clock signal S_{CLK}(t). For example, the local oscillator 402 of the primary MMIC 501 may generate the RF oscillator signal S_{LO}(t) based on the clock signal S_{CLK}(t). The clock signal S_{CLK}(t) may have a clock frequency in a megahertz (MHz) range (e.g., 200 MHz), whereas the LO signal may have an LO frequency f_{LO} of a plurality of GHz (e.g., 76-81 GHz) or a corresponding divided value (e.g., 13 GHz or 39 GHz).

In some implementations, the microcontroller 505 may be configured to transmit control signals to the MMICs 501, 502, 503, and 504 using a control signal bus 506. The control signals may be used to control one or more functions of the MMICs 501, 502, 503, and 504. For example, the microcontroller 505 may transmit control signals to control the operating modes of the MMICs 501, 502, 503, and 504 according to the operation mode sequence. Additionally, the microcontroller 505 may transmit control signals to the primary MMIC 501 for controlling (e.g., enable or disable) the LO distribution of the RF oscillator signal S_{LO}(t). The control signals may be received at a control input CTRL of the MMICs 501, 502, 503, and 504. The control signals may be provided from the control input CTRL to a processing component of a respective MMIC. For example, the processing component may be an integrated controller or other processing circuitry of the respective MMIC.

In some implementations, each MMIC 501, 502, 503, and 504 may further include a data output Dout for transmitting data. The data from each MMIC 501, 502, 503, and 504 may be transmitted as feedback information to the microcontroller 505 that receives the data at a data input Din. Based on the received data from one or more of the MMICs 501, 502, 503, and 504, the microcontroller 505 may control one or more functions of one or more of the MMICs 501-504. For example, the microcontroller 505 may be configured to receive the data from the MMICs 501, 502, 503, and 504 via a data bus 507 and generate control signals based oil the received data. In some implementations, the control signals may be disable signals or enable signals that control the activation and deactivation of the radar signal channels, including transmitting channels and/or receiving channels, at each MMIC 501, 502, 503, and 504. In some implementations, the control signals may be phase control signals that control a phase of one or more of the radar signal channels. For example, the phase control signals may be used to control a phase setting of the phase shifters 406 of the MMICs 501, 502, 503, and 504.

Each MMIC 501, 502, 503, and 504 may include a control circuit 510-513 (e.g., a radar operation controller) that is configured to control one or more components of a corresponding MMIC. A control circuit 510-513 may implement some of the functionality of the controller 116 described in connection with FIG. 3. For example, each control circuit 510-513 may trigger a start of a radar frame that comprises a sequence of frequency ramps for its corresponding MMIC. In some implementations, each control circuit 510-513 may initiate a radar frame by starting a transmission of the sequence of frequency ramps. Each control circuit 510-513 may initiate the radar frame based on receiving a trigger. In some implementations, each control circuit 510-513 may generate phase information based on a monitoring operation and output the phase information via a respective data output Dout. In some implementations, each control circuit 510-513 may receive control signals from the microcontroller 505.

Each control circuit 510-513 may include control logic configured to set a corresponding MMIC in one of a plurality of operation modes. The plurality of operation modes may include a radar operation mode and at least one of a monitoring mode or a calibration mode. During monitoring mode, one or more monitoring functions may be performed, including a transmit monitoring function for monitoring a transmit channel, a receive monitoring function for monitoring a receive channel, and/or an event monitoring function for monitoring for a trigger event. In some implementations, monitoring the receive channel may include monitoring for and detecting interference (e.g., interfering signals or interference signals), for example, from another radar device. During calibration mode, one or more calibration functions may be performed, including adjusting one or more parameters of one or more components of a transmit channel and/or a receive channel. For example, one or more parameters may include parameters f_{START}, f_{STOP}, T_{CHIRP} of the local oscillator 402, a gain of the RF power amplifier 404, a phase of the phase shifter 406, a gain of the amplifier 410, a filter setting of the baseband signal processing circuit 110, and/or a sampling rate of the ADC 112. The local oscillator 402 may be configured by a control circuit to generate the RF oscillator signal S_{LO}(t) as a frequency ramp signal during the radar operation mode, and may generate the RF oscillator signal S_{LO}(t) as a single frequency signal during the calibration mode and the monitoring mode of the corresponding MMIC.

The control circuit 510 of the primary MMIC 501 may include an LO distribution circuit coupled to the LO output LOₒᵤₜ (e.g., the LO output terminal) of the primary MMIC 501. The LO distribution circuit may be configured to receive the RF oscillator signal S_{LO}(t) from the local oscillator 402 and enable or disable the LO distribution of the RF oscillator signal S_{LO}(t) based on a first control signal indicating whether the LO distribution of the RF oscillator signal S_{LO}(t) (e.g., a first LO signal) is enabled or disabled. In some implementations, the LO distribution circuit may be a switch that connects the local oscillator 402 to the LO output LOₒᵤₜ or disconnects the local oscillator 402 from the LO output LOₒᵤₜ. The control logic may provide the first control signal to the LO distribution circuit for enabling or disabling the LO distribution. The first control signal may be configured to enable the LO distribution during the radar operation mode of the primary MMIC 501 and disable the LO distribution during at least one of the calibration mode or the monitoring mode of the primary MMIC 501.

In some implementations, the LO distribution of the RF oscillator signal S_{LO}(t) may be enabled during the radar operation mode of the primary MMIC 501 (and the secondary MMICs 502, 503, and 504), disabled during the calibration mode and/or the monitoring mode of the primary MMIC 501, and disabled during a calibration mode or a monitoring mode of any of the secondary MMICs 502, 503, and 504. The primary MMIC 501 and the secondary MMICs 502, 503, and 504 may be simultaneously operated in the radar operation mode. The primary MMIC 501 and the secondary MMICs 502, 503, and 504 may be simultaneously operated respective calibration modes. However, in some implementations, the primary MMIC 501 and the secondary MMICs 502, 503, and 504 may be placed in respective calibration modes in different time slots or different time intervals. The primary MMIC 501 and the secondary MMICs 502, 503, and 504 may be simultaneously operated respective monitoring modes. However, in some implementations, the primary MMIC 501 and the secondary MMICs 502, 503, and 504 may be placed in respective calibration modes in different time slots or different time intervals.

The LO inputs LOᵢₙ (e.g., LO input terminals) of respective secondary MMICs 502, 503, and 504 may be configured to receive, as a first LO signal, the RF oscillator signal S_{LO}(t) from the primary MMIC 501 during a mode in which the LO distribution of the RF oscillator signal S_{LO}(t) is enabled. The clock inputs CLKin (e.g., clock input terminals) of respective secondary MMICs 502, 503, and 504 may receive the clock signal S_{CLK}(t) during the plurality of operation modes. In other words, the clock signal S_{CLK}(t) may be received by the secondary MMICs 502, 503, and 504 for all operation modes. Each secondary MMIC 502, 503, and 504 may include a respective LO generation circuit (e.g., a respective local oscillator 402) configured to generate a second LO signal based on the clock signal S_{CLK}(t). Each secondary MMIC 502, 503, and 504 may include a respective LO switching circuit configured to receive a control signal indicating whether the LO distribution of the RF oscillator signal S_{LO}(t) is enabled or disabled, enable the respective LO generation circuit based on the control signal indicating that the LO distribution of the RF oscillator signal S_{LO}(t) is disabled, and disable the respective LO generation circuit based on the control signal indicating that the LO distribution of the RF oscillator signal S_{LO}(t) is enabled. The LO distribution of the RF oscillator signal S_{LO}(t) may be enabled during the radar operation mode of a secondary MMIC 502, 503, and 504 and may be disabled during at least one of the calibration mode or the monitoring mode of a secondary MMIC 502, 503, and 504.

In some implementations, a respective LO switching circuit may receive the first LO signal from a respective LO input LOᵢₙ, receive the second LO signal from the respective LO generation circuit, and a first control signal indicating whether the LO distribution of the RF oscillator signal S_{LO}(t) is enabled or disabled. The respective LO switching circuit may output the first LO signal based on the first control signal indicating that the LO distribution of the RF oscillator signal S_{LO}(t) is enabled, and may output the second LO signal based on the first control signal indicating that the LO distribution of the RF oscillator signal S_{LO}(t) is disabled.

As indicated above, FIG. 5 is provided as an example. Other examples may differ from what is described with regard to FIG. 5. The number and arrangement of devices and components shown in FIG. 5 are provided as an example. In practice, there may be additional devices or components, fewer devices or components, different devices or components, or differently arranged devices or components than those shown in FIG. 5. Furthermore, two or more devices or components shown in FIG. 5 may be implemented within a single device or component, or a single device or component shown in FIG. 5 may be implemented as multiple, distributed devices or components. Additionally, or alternatively, a set of devices or components (e.g., one or more devices or components) shown in FIG. 5 may perform one or more functions described as being performed by another set of devices or components shown in FIG. 5.

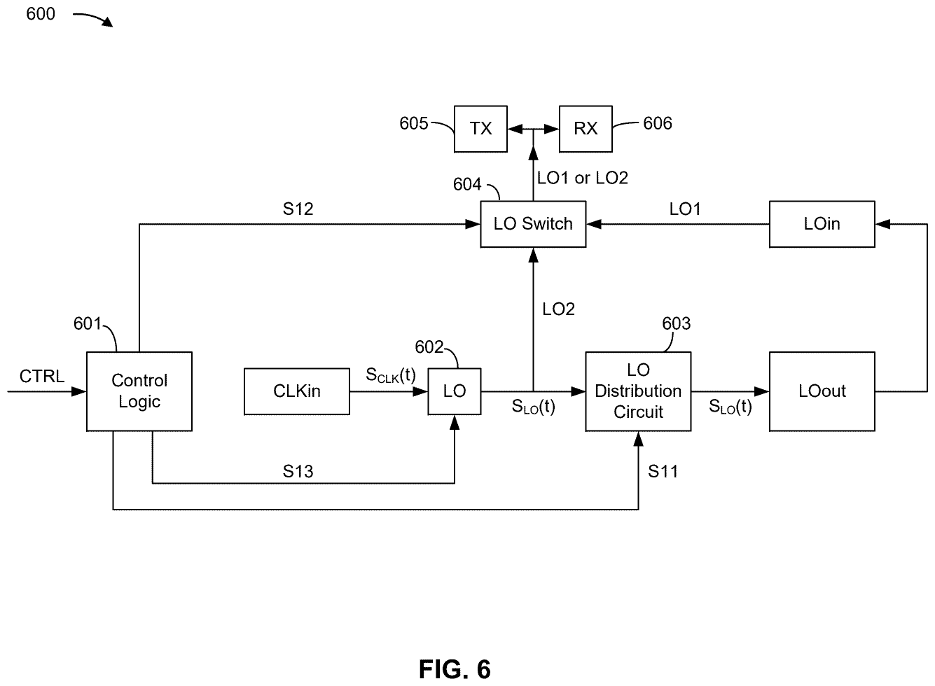

FIG. 6 illustrates a control circuit 600 for a primary MMIC according to one or more implementations. The control circuit 600 may correspond to the control circuit 510 of the primary MMIC 501 described in connection with FIG. 5. The control circuit 600 may include a control logic 601, an LO generation circuit 602 (e.g., local oscillator 402), an LO distribution circuit 603, and an LO switching circuit 604.

The LO generation circuit 602 may receive the clock signal S_{CLK}(t) from the clock input CLKin and generate the RF oscillator signal S_{LO}(t) based on the clock signal S_{CLK}(t).

The LO distribution circuit 603 may be coupled to the LO output LOₒᵤₜ and may be configured to receive the RF oscillator signal S_{LO}(t) from the LO generation circuit 602. In addition, the LO distribution circuit 603 may enable or disable the LO distribution of the RF oscillator signal S_{LO}(t) based on a first control signal S11 indicating whether the LO distribution of the RF oscillator signal S_{LO}(t) is enabled or disabled.

The control logic 601 may be coupled to the control input CTRL for receiving control signals from the microcontroller 505. The control logic 601 may provide the first control signal S11 to the LO distribution circuit 603 for enabling or disabling the LO distribution. The first control signal S11 may enable the LO distribution during a radar operation mode, and may disable the LO distribution during at least one of a calibration mode or a monitoring mode. Thus, the LO distribution circuit 603 may receive the first control signal S11, and enter into an enabled state or a disabled state based on the first control signal S11. While the LO distribution is in the enabled state, the LO distribution circuit 603 may provide the RF oscillator signal S_{LO}(t) to the LO output LOₒᵤₜ. While the LO distribution is in the disabled state, the LO distribution circuit 603 may prevent the RF oscillator signal S_{LO}(t) from being provided to the LO output LOₒᵤₜ. In some implementations, the LO distribution circuit 603 may be a switch having a switch state controlled by the first control signal S11.

The LO input LOᵢₙ may receive the RF oscillator signal S_{LO}(t) from the LO output LOₒᵤₜ during the radar operation mode and provide the RF oscillator signal S_{LO}(t) to the LD switching circuit 604 as a first LO signal LO1. Additionally, the LO switching circuit 604 may receive the RF oscillator signal S_{LO}(t) from the LO generation circuit 602 as a second LO signal LO2. The LO switching circuit 604 may receive a second control signal S12 from the control logic 601. The second control signal S12 may indicate whether the LO distribution of the RF oscillator signal S_{LO}(t) (e.g., the first LO signal LO1) is enabled or disabled. In some implementations, the first control signal S11 and the second control signal S12 are a same control signal. The LO switching circuit 604 may output the first LO signal LO1 based on the second control signal S12 indicating that the LO distribution of the RF oscillator signal S_{LO}(t) is enabled. The LO switching circuit 604 may output the second LO signal LO2 based on the second control signal S12 indicating that the LO distribution of the RF oscillator signal S_{LO}(t) is disabled. In some implementations, the LO switching circuit 604 may be a multiplexer.

The LO switching circuit 604 may provide the first LO signal LO1 or the second LO signal LO2 to transmitter circuitry 605 (e.g., one or more TX channels) and/or receiver circuitry 606 (e.g., one or more RX channels) based on the second control signal S12. The transmitter circuitry 605 and/or the receiver circuitry 606 may be configured to operate based on the first LO signal LO1 or the second LO signal LO2. For example, the transmitter circuitry 605 and/or the receiver circuitry 606 may use the first LO signal LO1 or the second LO signal LO2 as similarly described in connection with FIG. 4.

The control logic 601 may switch the primary MMIC between the plurality of operation modes according to an operation mode sequence, wherein the operation mode sequence comprises a first time interval during which the primary MMIC is set in the radar operation mode, a second time interval during which the primary MMIC is set in at least one of the calibration mode or the monitoring mode, and a third time interval during which the primary MMIC is set in the radar operation mode, the second time interval being between the first time interval and the third time interval.

Additionally, the control logic 601 may provide a third control signal S13 to the LO generation circuit 602 for controlling an operation of the LO generation circuit 602. For example, the LO generation circuit 602 may be configured by the third control signal S13 to generate the RF oscillator signal S_{LO}(t) as a single frequency signal during the calibration mode and the monitoring mode of the primary MMIC. The LO generation circuit 602 may be configured by the third control signal S13 to generate the RF oscillator signal S_{LO}(t) as a frequency ramp signal during the radar operation mode of the primary MMIC.

As indicated above, FIG. 6 is provided as an example. Other examples may differ from what is described with regard to FIG. 6.

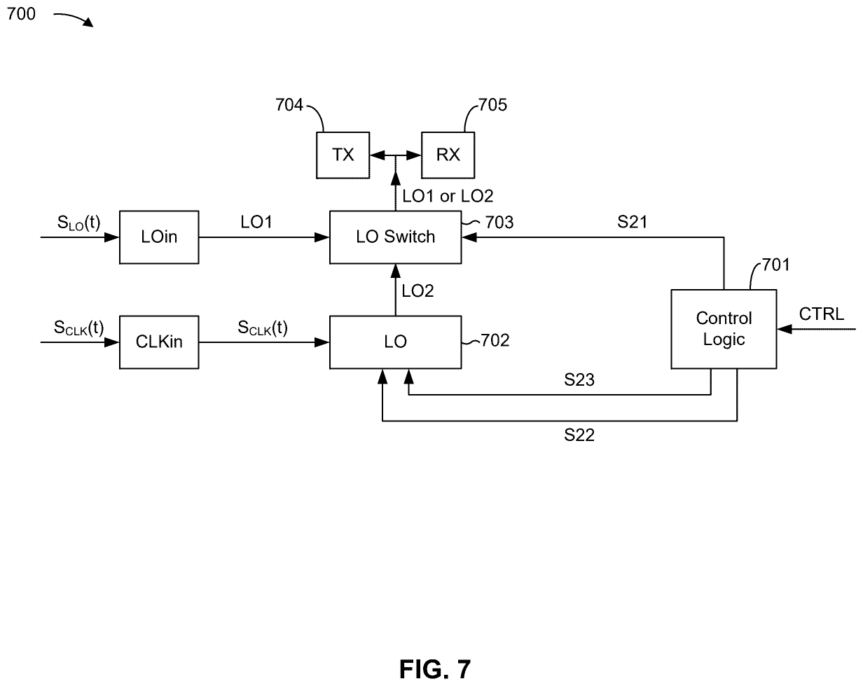

FIG. 7 illustrates a control circuit 700 for a secondary MMIC according to one or more implementations. The control circuit 700 may correspond to one of control circuits 511-513 of the secondary MMICs 502, 503, and 504 described in connection with FIG. 5. The control circuit 700 may include a control logic 701, an LO generation circuit 702 (e.g., local oscillator 402), and an LO switching circuit 703.

The LO input LOᵢₙ may receive the RF oscillator signal S_{LO}(t) from a primary MMIC during LO distribution and provide the RF oscillator signal S_{LO}(t) to the LO switching circuit 703 as a first LO signal LO1.

The LO generation circuit 702 may receive the clock signal S_{CLK}(t) (e.g., the system clock signal) from the clock input CLKin and generate a second LO signal LO2 based on the clock signal S_{CLK}(t). The LO generation circuit 702 may provide the second LO signal LO2 to the LO switching circuit 703.

The LO switching circuit 703 may receive a first control signal S21, from the control logic 701, indicating whether the LO distribution of the RF oscillator signal S_{LO}(t) (e.g., the first LO signal LO1) is enabled or disabled. The LO switching circuit 703 may output the first LO signal LO1 based on the first control signal S21 indicating that the LO distribution of the RF oscillator signal S_{LO}(t) is enabled. The LO switching circuit 703 may output the second LO signal LO2 based on the first control signal S21 indicating that the LO distribution of the RF oscillator signal S_{LO}(t) is disabled.

The control logic 601 may be coupled to the control input CTRL for receiving control signals from the microcontroller 505. The control logic 601 may generate control signals, including the first control signal S21, based on control signals received from the microcontroller 505.

The L generation circuit 702 may include a PLL. In some implementations, the LO generation circuit 702 may receive a second control signal S22 from the control logic 601 indicating whether the LO distribution of the RF oscillator signal S_{LO}(t) is enabled or disabled. In some implementations, the first control signal S21 and the second control signal S22 are a same control signal. The LO generation circuit 702 may disable the PLL based on the second control signal S22 indicating that the LO distribution of the RF oscillator signal S_{LO}(t) is enabled, and may enable the PLL based on the second control signal S22 indicating that the LD distribution of the RF oscillator signal S_{LO}(t) is disabled. The LO generation circuit 702 may generate the second LO signal LO2 as a single frequency signal for use during at least one of a calibration mode or a monitoring mode. In some implementations, the LO generation circuit 702 may receive a third control signal S23 from the control logic 601 indicating one or more control parameters, such as frequency, for the single frequency signal.

The LO switching circuit 703 may provide the first LO signal LO1 or the second LO signal LO2 to transmitter circuitry 704 (e.g., one or more TX channels) and/or receiver circuitry 705 (e.g., one or more RX channels) based on the first control signal S21. Thus, the LO switching circuit 703 may be coupled to a radar circuit of the secondary MMIC and configured to output either the first LO signal LO1 or the second LO signal LO2 to the radar circuit based on the first control signal S21. The transmitter circuitry 704 and/or the receiver circuitry 705 may be configured to operate based on the first LO signal LO1 or the second LO signal LO2. For example, the transmitter circuitry 704 and/or the receiver circuitry 705 may use the first LO signal LO1 or the second LO signal LO2 as similarly described in connection with FIG. 4. The first LO signal LO1 may be a frequency ramp signal during LO distribution, which may correspond to the radar operation mode. In contrast, the second LO signal LO2 may oscillate at a single frequency.

The control logic 701 may switch the secondary MMIC between the plurality of operation modes according to an operation mode sequence, wherein the operation mode sequence comprises a first time interval during which the secondary MMIC is set in the radar operation mode, a second time interval during which the secondary MMIC is set in at least one of the calibration mode or the monitoring mode, and a third time interval during which the secondary MMIC is set in the radar operation mode, the second time interval being between the first time interval and the third time interval.

As indicated above, FIG. 7 is provided as an example. Other examples may differ from what is described with regard to FIG. 7.

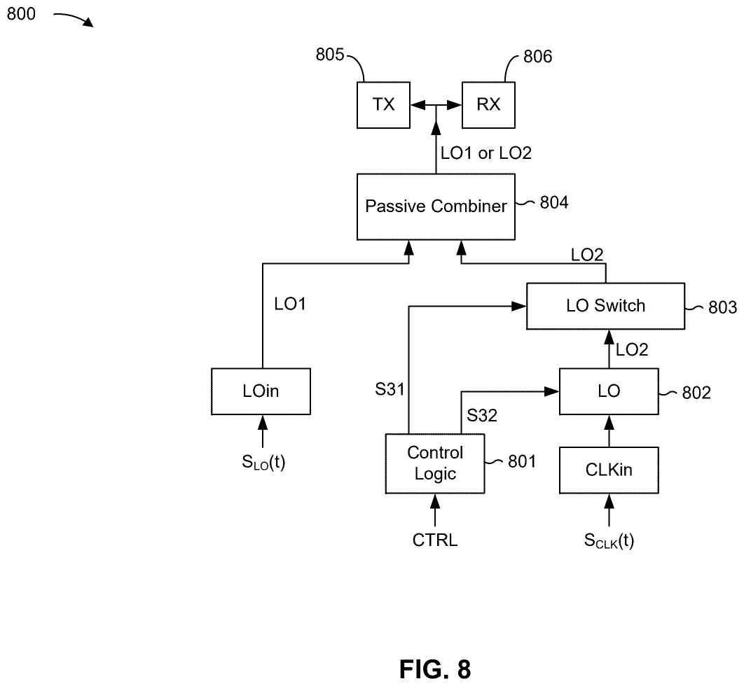

FIG. 8 illustrates a control circuit 800 for a secondary MMIC according to one or more implementations. The control circuit 800 may correspond to one of control circuits 511-513 of the secondary MMICs 502, 503, and 504 described in connection with FIG. 5. The control circuit 800 may include a control logic 801, an LO generation circuit 802 (e.g., local oscillator 402), an LO switching circuit 803, and a passive combiner 804.

The LO input LOₘ may receive the RF oscillator signal S_{LO}(t) from a primary MMIC during LO distribution and provide the RF oscillator signal S_{LO}(t) to the passive combiner 804 as a first LO signal LO1.

The LO generation circuit 802 may receive the clock signal S_{CLK}(t) (e.g., the system clock signal) from the clock input CLKin and generate a second LO signal LO2 based on the clock signal S_{CLK}(t). The LO generation circuit 802 may provide the second LO signal LO2 to the LO switching circuit 803.

The LO switching circuit 803 may receive a first control signal S31, from the control logic 801, indicating whether the LO distribution of the RF oscillator signal S_{LO}(t) (e.g., the first LO signal LO1) is enabled or disabled. The LO switching circuit 803 may prevent the second LO signal LO2 from being provided to the passive combiner 804 based on the first control signal S31 indicating that the LO distribution of the RF oscillator signal S_{LO}(t) is enabled. Alternatively, the LO switching circuit 803 may output the second LO signal LO2 to the passive combiner 804 based on the first control signal 31 indicating that the LO distribution of the RF oscillator signal S_{LO}(t) is disabled. The LO switching circuit 803 may be a switch, an amplifier with an adjustable gain, or an attenuator.

Additionally, or alternatively, the control logic 801 may enable the LO generation circuit 802 based on a second control signal S32 indicating that the LO distribution of the RF oscillator signal S_{LO}(t) is disabled, and disable the LO generation circuit 802 based on the second control signal 32 indicating that the LO distribution of the RF oscillator signal S_{LO}(t) is enabled. For example, the second control signal S32 may enable or disable a PLL of the LO generation circuit 802. In some implementations, the first control signal S31 and the second control signal 32 are a same control signal.

The LO generation circuit 802 and/or the LO switching circuit 803 may form an enabling-disabling circuit configured to receive one or more control signals S31 or S32 indicating whether the LO distribution of the RF oscillator signal S_{LO}(t) (e.g., the first LO signal LO1) is enabled or disabled, enable the second LO signal LO2 based on the one or more control signals S31 or S32 indicating that the LO distribution of the RF oscillator signal S_{LO}(t) is disabled, and disable the second LO signal LO2 based on the one or more control signals S31 or S32 indicating that the LO distribution of the RF oscillator signal S_{LO}(t) is enabled.

The passive combiner 804 may receive the first LO signal LO1 when the LO distribution of the RF oscillator signal S_{LO}(t) is enabled, or may receive the second LO signal LO2 when the LO distribution of the RF oscillator signal S_{LO}(t) is disabled. As a result, the passive combiner 804 may output either the first LO signal LO1 or the second LO signal LO2 to transmitter circuitry 805 (e.g., one or more TX channels) and/or receiver circuitry 806 (e.g., one or more RX channels) based on at least one of the first control signal S31 or the second control signal S32.

As indicated above, FIG. 8 is provided as an example. Other examples may differ from what is described with regard to FIG. 8.

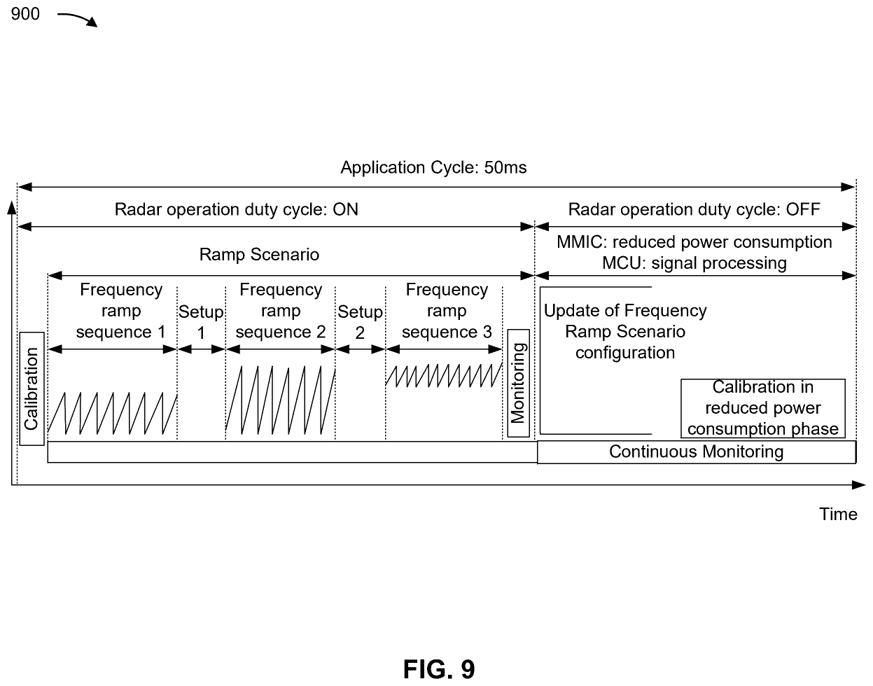

FIG. 9 illustrates an example application cycle 900 according to one or more implementations. The application cycle 900 may include a radar operation duty cycle, including an ON period and an OFF period. During the ON period, the radar MMIC 106 may be configured to perform a warm-up calibration before running a ramp scenario. In addition, during the ON period, the radar MMIC 106 may be configured to perform a ramp scenario during which multiple frequency ramp sequences (e.g., frequency ramp sequence 1, frequency ramp sequence 2, and frequency ramp sequence 3) are transmitted according to one or more ramp parameters. In this example, the frequency ramp sequences are generated according to different sets of ramp parameters. However, the same set of ramp parameters may be used for the frequency ramp sequences. Consecutive frequency ramp sequences may be separated by a long wait ramp segment during which the frequency ramps are not generated (e.g., the frequency of the frequency-modulated ramp signal is held constant). Put another way, during frequency ramp generation, the LO signal may be an FMCW signal for generating frequency ramps. When frequency ramps are not generated, such as during calibration, monitoring, setup intervals, or wait intervals, the LO signal may be a single-frequency (e.g., constant frequency) continuous-wave signal.

The frequency ramps of each ramp scenario may be preconfigured with one or more ramp parameters, such as start frequency, stop frequency, bandwidth, power amplifier setting, transmit phase, and duration. For example, each frequency ramp of a ramp scenario may have a same start frequency value, a same stop frequency value, and a same duration value. Different ramp scenarios may be configured with different ramp parameter values.

A setup operation (e.g., setup 1 and setup 2) may be performed by the radar MMIC 106 between frequency ramp sequences (e.g., during the long wait ramp segment). A setup operation may be used to change one or more ramp parameters or may be used to perform a calibration between the frequency ramp sequences.

In addition, during the ON period, the radar MMIC 106 may be configured to perform monitoring for reflected radar signals. During the OFF period, the radar MMIC 106 may continue to monitor for reflected radar signals but may no longer transmit radar signals. As a result, during the OFF period, the radar MMIC 106 may be configured into a reduced power consumption mode. During the OFF period, the microcontroller 505 may process, via signal processing, the results of the monitoring provided by the radar MMIC 106.

The application cycles may differ in the following ways: by a type of calibration and monitoring that are performed, and which ramp scenario is used. Ramp scenarios include frequency ramp sequences that further include a ramp set (e.g., shown as a triangular waveform). The ramp set may differ in terms of start frequency f_{START}, frequency ramp slope, stop frequency f_{STOP}, ramp start time T_{START}, time interval T_{CHIRP}, transmission power, and transmission phase. Additionally, if there are multiple transmit channels, a ramp set may be defined according to which transmit channel is specified for transmitting the ramp set.

The LO distribution may be enabled during each radar operation (e.g., during each frequency ramp sequence), and may be disabled in the ON period during the calibration, the monitoring, the setup intervals, and/or the wait intervals. Calibration and/or monitoring may be performed during the setup intervals and/or the wait intervals. In addition, the LO distribution may be disabled for an entire OFF period of the radar operation duty cycle.

As indicated above, FIG. 9 is provided as an example. Other examples may differ from what is described with regard to FIG. 9.

The following provides an overview of some Aspects of the present disclosure:

Aspect 1: A radar MMIC, comprising: a control logic configured to set the radar MMIC in one of a plurality of operation modes, the plurality of operation modes including a radar operation mode, and at least one of a monitoring mode or a calibration mode; a system clock terminal configured to receive a system clock signal; an LO generation circuit configured to generate an LO signal based on the system clock signal, wherein the LO generation circuit is configured to generate the LO signal as a frequency ramp signal during the radar operation mode; an LO output terminal configured to output the LO signal for LO distribution to another MMIC; and an LO distribution circuit coupled to the LO output terminal and configured to receive the LO signal from the LO generation circuit and enable or disable the LO distribution of the LO signal based on a first control signal indicating whether the LO distribution of the LO signal is enabled or disabled, wherein the control logic is configured to provide the first control signal to the LO distribution circuit for enabling or disabling the LO distribution, wherein the first control signal is configured to enable the LO distribution during the radar operation mode of the radar MMIC and disable the LO distribution during at least one of the calibration mode or the monitoring mode of the radar MMIC.

Aspect 2: The radar MMIC of Aspect 1, wherein the LO generation circuit is configured to generate the LO signal as a single frequency signal during the calibration mode and the monitoring mode of the radar MMIC.

Aspect 3: The radar MMIC of any of Aspects 1-2, wherein the control logic configured to switch the radar MMIC between the plurality of operation modes according to an operation mode sequence.

Aspect 4: The radar MMIC of any of Aspects 1-3, further comprising: a clock output terminal configured to output the system clock signal for system clock distribution, wherein the clock output terminal is configured to distribute the system clock signal to a secondary radar MMIC that is configurable into the plurality of operation modes, wherein the LO output terminal is configured to distribute the LO signal to the secondary radar MMIC, and wherein the first control signal is configured to enable the LO distribution during the radar operation mode of the secondary radar MMIC and disable the LO distribution during at least one of the calibration mode or the monitoring mode of the secondary radar MMIC.

Aspect 5: The radar MMIC of any of Aspects 1-4, wherein the LO distribution is configured to: receive the first control signal and enter into an enabled state or a disabled state based on the first control signal, while the LO distribution is in the enabled state, provide the LO signal to the LO output terminal, and while the LO distribution is in the disabled state, prevent the LO signal from being provided to the LO output terminal.

Aspect 6: The radar MMIC of any of Aspects 1-5, further comprising: an LO input terminal configured to receive the LO signal from the LO output terminal during the radar operation mode of the radar MMIC; and an LO switching circuit configured to receive the LO signal from the LO input terminal as a first LO signal and receive the LO signal from the LO generation circuit as a second LO signal, wherein the LO switching circuit is configured to receive a second control signal indicating whether the LO distribution of the LO signal is enabled or disabled, wherein the LO switching circuit is configured to output the first LO signal based on the second control signal indicating that the LO distribution of the LO signal is enabled, and wherein the LO switching circuit is configured to output the second LO signal based on the second control signal indicating that the LO distribution of the LO signal is disabled.

Aspect 7: The radar MMIC of Aspect 6, further comprising: transmitter circuitry configured to transmit radar signals; and receiver circuitry configured to receive echoes of the radar signals, wherein the LO switching circuit is configured to provide the first LO signal or the second LO signal to the transmitter circuitry and the receiver circuitry based on the second control signal, and the transmitter circuitry and the receiver circuitry are configured to operate based on the first LO signal or the second LO signal.

Aspect 8: The radar MMIC of Aspect 6, wherein the LO distribution of the LO signal is enabled during the radar operation mode of the radar MMIC, disabled during the calibration mode and the monitoring mode of the radar MMIC, and disabled during a calibration mode or a monitoring mode of a secondary radar MMIC that is coupled to the radar MMIC in a cascaded configuration.

Aspect 9: A radar MMIC, comprising: a control logic configured to set the radar MMIC in a plurality of operation modes, including a radar operation mode and at least one of a monitoring mode or a calibration mode; an LO input terminal configured to receive a first LO signal from outside of the radar MMIC during a mode in which LO distribution of the first LO signal is enabled; a clock input terminal configured to receive a system clock signal during the plurality of operation modes; an LO generation circuit configured to generate a second LO signal based on the system clock signal; and an LO switching circuit configured to: receive the first LO signal from the LO input terminal, the second LO signal from the LO generation circuit, and a first control signal indicating whether the LO distribution of the first LO signal is enabled or disabled, output the first LO signal based on the first control signal indicating that the LO distribution of the first LO signal is enabled, and output the second LO signal based on the first control signal indicating that the LO distribution of the first LO signal is disabled, wherein the LO distribution of the first LO signal is enabled during the radar operation mode of the radar MMIC and disabled during at least one of the calibration mode or the monitoring mode of the radar MMIC.

Aspect 10: The radar MMIC of Aspect 9, wherein the LO generation circuit includes a PLL, wherein the LO generation circuit is configured to receive a second control signal indicating whether the LO distribution of the first LO signal is enabled or disabled, wherein the LO generation circuit is configured to disable the PLL based on the second control signal indicating that the LO distribution of the first LO signal is enabled, and wherein the LO generation circuit is configured to enable the PLL based on the second control signal indicating that the LO distribution of the first LO signal is disabled.

Aspect 11: The radar MMIC of any of Aspects 9-10, wherein the LO generation circuit is configured to generate the second LO signal as a single frequency signal.

Aspect 12: The radar MMIC of any of Aspects 9-11, wherein the first LO signal is a frequency ramp signal during the radar operation mode.

Aspect 13: The radar MMIC of any of Aspects 9-12, wherein the radar MMIC is a secondary radar MMIC configured to be coupled to a primary radar MMIC in a cascaded configuration, wherein the LO input terminal is configured to receive the first LO signal from the primary radar MMIC while the LO distribution of the first LO signal is enabled, and wherein the clock input terminal is configured to receive the system clock signal from the primary radar MMIC during the plurality of operation modes.

Aspect 14: The radar MMIC of Aspect 13, wherein the LO distribution of the first LO signal is enabled during a radar operation mode of the primary radar MMIC and disabled during at least one of a calibration mode or a monitoring mode of the primary radar MMIC.

Aspect 15: The radar MMIC of any of Aspects 9-14, further comprising: transmitter circuitry configured to transmit radar signals during the radar operation mode; and receiver circuitry configured to receive echoes of the radar signals during the radar operation mode, wherein the LO switching circuit is configured to provide the first LO signal or the second LO signal to the transmitter circuitry and the receiver circuitry based on the first control signal, and the transmitter circuitry and the receiver circuitry are configured to operate based on the first LO signal or the second LO signal.

Aspect 16: The radar MMIC of any of Aspects 9-15, wherein the control logic is configured to switch the radar MMIC between the plurality of operation modes according to an operation mode sequence, wherein the operation mode sequence comprises a first time interval during which the radar MMIC is set in the radar operation mode, a second time interval during which the radar MMIC is set in at least one of the calibration mode or the monitoring mode, and a third time interval during which the radar MMIC is set in the radar operation mode, the second time interval being between the first time interval and the third time interval.

Aspect 17: The radar MMIC of any of Aspects 9-16, wherein the LO switching circuit is coupled to a radar circuit of the radar MMIC and configured to output either the first LO signal or the second LO signal to the radar circuit based on the first control signal.

Aspect 18: A cascaded radar system, comprising: a primary radar MMIC; and a secondary radar MMIC, wherein the primary radar MMIC comprises: a first control logic configured to set the radar MMIC in one of a first plurality of operation modes, the first plurality of operation modes including a first radar operation mode, and at least one of a first monitoring mode or a first calibration mode; a system clock terminal configured to receive a system clock signal; a first LO generation circuit configured to generate a first LO signal based on the system clock signal, wherein the first LO generation circuit is configured to generate the first LO signal as a first frequency ramp signal during the first radar operation mode; a clock output terminal configured to output the system clock signal for system clock distribution to the secondary MMIC; an LO output terminal configured to output the LO signal for LO distribution to the secondary MMIC; and an LO distribution circuit coupled to the LO output terminal and configured to receive the first LO signal from the first LO generation circuit and enable or disable the LO distribution of the first LO signal based on a first control signal indicating whether the LO distribution of the first LO signal is enabled or disabled, wherein the first control logic is configured to provide the first control signal to the LO distribution circuit for enabling or disabling the LO distribution, wherein the first control signal is configured to enable the LO distribution during the first radar operation mode of the primary radar MMIC and disable the LO distribution during at least one of the first calibration mode or the first monitoring mode of the primary radar MMIC.

Aspect 19: The cascaded radar system of Aspect 18, wherein the secondary radar MMIC comprises: a second control logic configured to set the radar MMIC in a second plurality of operation modes, including a second radar operation mode and at least one of a second monitoring mode or a second calibration mode; an LO input terminal configured to receive the first LO signal from the primary radar MMIC during a mode in which the LO distribution of the first LO signal is enabled; a clock input terminal configured to receive the system clock signal during the second plurality of operation modes; a second LO generation circuit configured to generate a second LO signal based on the system clock signal; and a radar circuit configured to use the first LO signal or the second LO signal based on the LO distribution of the first LO signal being enabled or disabled.

Aspect 20: The cascaded radar system of Aspect 19, wherein the LO distribution of the first LO signal is enabled during the second radar operation mode of the secondary radar MMIC and disabled during at least one of the second calibration mode or the second monitoring mode of the secondary radar MMIC.

Aspect 21: The cascaded radar system of Aspect 19, wherein the secondary radar MMIC comprises: an LO switching circuit configured to: receive the first LO signal from the LO input terminal, the second LO signal from the second LO generation circuit, and a second control signal indicating whether the LO distribution of the first LO signal is enabled or disabled, output the first LO signal to the radar circuit based on the second control signal indicating that the LO distribution of the first LO signal is enabled, and output the second LO signal to the radar circuit based on the second control signal indicating that the LO distribution of the first LO signal is disabled.

Aspect 22: The cascaded radar system of Aspect 19, wherein the secondary radar MMIC comprises: an LO switching circuit configured to receive a second control signal indicating whether the LO distribution of the first LO signal is enabled or disabled, enable the second LO generation circuit based on the second control signal indicating that the LO distribution of the first LO signal is disabled, and disable the second LO generation circuit based on the second control signal indicating that the LO distribution of the first LO signal is enabled.

Aspect 23: The cascaded radar system of any of Aspects 18-22, wherein the first control logic is configured to switch the primary radar MMIC between the first plurality of operation modes according to an operation mode sequence, wherein the operation mode sequence comprises a first time interval during which the primary radar MMIC is set in the first radar operation mode, a second time interval during which the primary radar MMIC is set in at least one of the first calibration mode or the first monitoring mode, and a third time interval during which the primary radar MMIC is set in the first radar operation mode, the second time interval being between the first time interval and the third time interval.

Aspect 24: A radar MMIC, comprising: a control logic configured to set the radar MMIC in a plurality of operation modes, including a radar operation mode and at least one of a monitoring mode or a calibration mode; an LO input terminal configured to receive a first LO signal from outside of the radar MMIC during a mode in which LO distribution of the first LO signal is enabled; a clock input terminal configured to receive a system clock signal during the plurality of operation modes; an LO generation circuit configured to generate a second LO signal based on the system clock signal; an enabling-disabling circuit configured to receive a control signal indicating whether the LO distribution of the first LO signal is enabled or disabled, enable the second LO signal based on the control signal indicating that the LO distribution of the first LO signal is disabled, and disable the second LO signal based on the control signal indicating that the LO distribution of the first LO signal is enabled; and a combiner circuit configured to receive the first LO signal or the second LO signal based on the LO distribution being enabled or disabled, respectively; and a radar circuit coupled to the combiner circuit and configured to receive either the first LO signal or the second LO signal, wherein the LO distribution of the first LO signal is enabled during the radar operation mode of the radar MMIC and disabled during at least one of the calibration mode or the monitoring mode of the radar MMIC.

Aspect 25: The radar MMIC of Aspect 24, wherein the enabling-disabling circuit is configured to enable the LO generation circuit based on the control signal indicating that the LO distribution of the first LO signal is disabled, and disable the LO generation circuit based on the control signal indicating that the LO distribution of the first LO signal is enabled.

Aspect 26: A system configured to perform one or more operations recited in one or more of Aspects 1-25.

Aspect 27: An apparatus comprising means for performing one or more operations recited in one or more of Aspects 1-25.

Aspect 28: A non-transitory computer-readable medium storing a set of instructions, the set of instructions comprising one or more instructions that, when executed by a device, cause the device to perform one or more operations recited in one or more of Aspects 1-25.

Aspect 29: A computer program product comprising instructions or code for executing one or more operations recited in one or more of Aspects 1-25.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, DSPs, general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Some implementations may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A radar monolithic microwave integrated circuit (MMIC), comprising:
a control logic configured to set the radar MMIC in one of a plurality of operation modes, the plurality of operation modes including a radar operation mode, and at least one of a monitoring mode or a calibration mode;
a system clock terminal configured to receive a system clock signal;
a local oscillator (LO) generation circuit configured to generate an LO signal based on the system clock signal, wherein the LO generation circuit is configured to generate the LO signal as a frequency ramp signal during the radar operation mode;
an LO output terminal configured to output the LO signal for LO distribution to another MMIC; and
an LO distribution circuit coupled to the LO output terminal and configured to receive the LO signal from the LO generation circuit and enable or disable the LO distribution of the LO signal based on a first control signal indicating whether the LO distribution of the LO signal is enabled or disabled,
wherein the control logic is configured to provide the first control signal to the LO distribution circuit for enabling or disabling the LO distribution, wherein the first control signal is configured to enable the LO distribution during the radar operation mode of the radar MMIC and disable the LO distribution during at least one of the calibration mode or the monitoring mode of the radar MMIC.

2. The radar MMIC of claim 1, wherein the LO generation circuit is configured to generate the LO signal as a single frequency signal during the calibration mode and the monitoring mode of the radar MMIC.

3. The radar MMIC of claim 1, wherein the control logic configured to switch the radar MMIC between the plurality of operation modes according to an operation mode sequence.

4. The radar MMIC of claim 1, further comprising:
a clock output terminal configured to output the system clock signal for system clock distribution,
wherein the clock output terminal is configured to distribute the system clock signal to a secondary radar MMIC that is configurable into the plurality of operation modes,
wherein the LO output terminal is configured to distribute the LO signal to the secondary radar MMIC, and
wherein the first control signal is configured to enable the LO distribution during the radar operation mode of the secondary radar MMIC and disable the LO distribution during at least one of the calibration mode or the monitoring mode of the secondary radar MMIC.

5. The radar MMIC of claim 1, wherein the LO distribution is configured to:
receive the first control signal and enter into an enabled state or a disabled state based on the first control signal,
while the LO distribution is in the enabled state, provide the LO signal to the LO output terminal, and
while the LO distribution is in the disabled state, prevent the LO signal from being provided to the LO output terminal.

6. The radar MMIC of claim 1, further comprising:
an LO input terminal configured to receive the LO signal from the LO output terminal during the radar operation mode of the radar MMIC; and
an LO switching circuit configured to receive the LO signal from the LO input terminal as a first LO signal and receive the LO signal from the LO generation circuit as a second LO signal,
wherein the LO switching circuit is configured to receive a second control signal indicating whether the LO distribution of the LO signal is enabled or disabled,
wherein the LO switching circuit is configured to output the first LO signal based on the second control signal indicating that the LO distribution of the LO signal is enabled, and
wherein the LO switching circuit is configured to output the second LO signal based on the second control signal indicating that the LO distribution of the LO signal is disabled.

7. The radar MMIC of claim 6, further comprising:
transmitter circuitry configured to transmit radar signals; and
receiver circuitry configured to receive echoes of the radar signals,
wherein the LO switching circuit is configured to provide the first LO signal or the second LO signal to the transmitter circuitry and the receiver circuitry based on the second control signal, and the transmitter circuitry and the receiver circuitry are configured to operate based on the first LO signal or the second LO signal.

8. The radar MMIC of claim 6, wherein the LO distribution of the LO signal is enabled during the radar operation mode of the radar MMIC, disabled during the calibration mode and the monitoring mode of the radar MMIC, and disabled during a calibration mode or a monitoring mode of a secondary radar MMIC that is coupled to the radar MMIC in a cascaded configuration.

9. A radar monolithic microwave integrated circuit (MMIC), comprising:
a control logic configured to set the radar MMIC in a plurality of operation modes, including a radar operation mode and at least one of a monitoring mode or a calibration mode;
a local oscillator (LO) input terminal configured to receive a first LO signal from outside of the radar MMIC during a mode in which LO distribution of the first LO signal is enabled;
a clock input terminal configured to receive a system clock signal during the plurality of operation modes;
an LO generation circuit configured to generate a second LO signal based on the system clock signal; and
an LO switching circuit configured to:
receive the first LO signal from the LO input terminal, the second LO signal from the LO generation circuit, and a first control signal indicating whether the LO distribution of the first LO signal is enabled or disabled,
output the first LO signal based on the first control signal indicating that the LO distribution of the first LO signal is enabled, and
output the second LO signal based on the first control signal indicating that the LO distribution of the first LO signal is disabled,
wherein the LO distribution of the first LO signal is enabled during the radar operation mode of the radar MMIC and disabled during at least one of the calibration mode or the monitoring mode of the radar MMIC.

10. The radar MMIC of claim 9, wherein the LO generation circuit includes a phase-locked loop (PLL),
wherein the LO generation circuit is configured to receive a second control signal indicating whether the LO distribution of the first LO signal is enabled or disabled,
wherein the LO generation circuit is configured to disable the PLL based on the second control signal indicating that the LO distribution of the first LO signal is enabled, and
wherein the LO generation circuit is configured to enable the PLL based on the second control signal indicating that the LO distribution of the first LO signal is disabled.

11. The radar MMIC of claim 9, wherein the LO generation circuit is configured to generate the second LO signal as a single frequency signal.

12. The radar MMIC of claim 9, wherein the first LO signal is a frequency ramp signal during the radar operation mode.

13. The radar MMIC of claim 9, wherein the radar MMIC is a secondary radar MMIC configured to be coupled to a primary radar MMIC in a cascaded configuration,
wherein the LO input terminal is configured to receive the first LO signal from the primary radar MMIC while the LO distribution of the first LO signal is enabled, and
wherein the clock input terminal is configured to receive the system clock signal from the primary radar MMIC during the plurality of operation modes.

14. The radar MMIC of claim 13, wherein the LO distribution of the first LO signal is enabled during a radar operation mode of the primary radar MMIC and disabled during at least one of a calibration mode or a monitoring mode of the primary radar MMIC.

15. The radar MMIC of claim 9, further comprising:
transmitter circuitry configured to transmit radar signals during the radar operation mode; and
receiver circuitry configured to receive echoes of the radar signals during the radar operation mode,
wherein the LO switching circuit is configured to provide the first LO signal or the second LO signal to the transmitter circuitry and the receiver circuitry based on the first control signal, and the transmitter circuitry and the receiver circuitry are configured to operate based on the first LO signal or the second LO signal.

16. The radar MMIC of claim 9, wherein the control logic is configured to switch the radar MMIC between the plurality of operation modes according to an operation mode sequence, wherein the operation mode sequence comprises a first time interval during which the radar MMIC is set in the radar operation mode, a second time interval during which the radar MMIC is set in at least one of the calibration mode or the monitoring mode, and a third time interval during which the radar MMIC is set in the radar operation mode, the second time interval being between the first time interval and the third time interval.

17. The radar MMIC of claim 9, wherein the LO switching circuit is coupled to a radar circuit of the radar MMIC and configured to output either the first LO signal or the second LO signal to the radar circuit based on the first control signal.

18. A cascaded radar system, comprising:
a primary radar monolithic microwave integrated circuit (MMIC); and
a secondary radar MMIC,
wherein the primary radar MMIC comprises:
a first control logic configured to set the radar MMIC in one of a first plurality of operation modes, the first plurality of operation modes including a first radar operation mode, and at least one of a first monitoring mode or a first calibration mode;
a system clock terminal configured to receive a system clock signal;
a first local oscillator (LO) generation circuit configured to generate a first LO signal based on the system clock signal, wherein the first LO generation circuit is configured to generate the first LO signal as a first frequency ramp signal during the first radar operation mode;
a clock output terminal configured to output the system clock signal for system clock distribution to the secondary MMIC;
an LO output terminal configured to output the LO signal for LO distribution to the secondary MMIC; and
an LO distribution circuit coupled to the LO output terminal and configured to receive the first LO signal from the first LO generation circuit and enable or disable the LO distribution of the first LO signal based on a first control signal indicating whether the LO distribution of the first LO signal is enabled or disabled,
wherein the first control logic is configured to provide the first control signal to the LO distribution circuit for enabling or disabling the LO distribution, wherein the first control signal is configured to enable the LO distribution during the first radar operation mode of the primary radar MMIC and disable the LO distribution during at least one of the first calibration mode or the first monitoring mode of the primary radar MMIC.

19. The cascaded radar system of claim 18, wherein the secondary radar MMIC comprises:
a second control logic configured to set the radar MMIC in a second plurality of operation modes, including a second radar operation mode and at least one of a second monitoring mode or a second calibration mode;
an LO input terminal configured to receive the first LO signal from the primary radar MMIC during a mode in which the LO distribution of the first LO signal is enabled;
a clock input terminal configured to receive the system clock signal during the second plurality of operation modes;
a second LO generation circuit configured to generate a second LO signal based on the system clock signal; and
a radar circuit configured to use the first LO signal or the second LO signal based on the LO distribution of the first LO signal being enabled or disabled.

20. The cascaded radar system of claim 19, wherein the LO distribution of the first LO signal is enabled during the second radar operation mode of the secondary radar MMIC and disabled during at least one of the second calibration mode or the second monitoring mode of the secondary radar MMIC.

21. The cascaded radar system of claim 19, wherein the secondary radar MMIC comprises:
an LO switching circuit configured to:
receive the first LO signal from the LO input terminal, the second LO signal from the second LO generation circuit, and a second control signal indicating whether the LO distribution of the first LO signal is enabled or disabled,
output the first LO signal to the radar circuit based on the second control signal indicating that the LO distribution of the first LO signal is enabled, and
output the second LO signal to the radar circuit based on the second control signal indicating that the LO distribution of the first LO signal is disabled.

22. The cascaded radar system of claim 19, wherein the secondary radar MMIC comprises:
an LO switching circuit configured to receive a second control signal indicating whether the LO distribution of the first LO signal is enabled or disabled, enable the second LO generation circuit based on the second control signal indicating that the LO distribution of the first LO signal is disabled, and disable the second LO generation circuit based on the second control signal indicating that the LO distribution of the first LO signal is enabled.

23. The cascaded radar system of claim 18, wherein the first control logic is configured to switch the primary radar MMIC between the first plurality of operation modes according to an operation mode sequence, wherein the operation mode sequence comprises a first time interval during which the primary radar MMIC is set in the first radar operation mode, a second time interval during which the primary radar MMIC is set in at least one of the first calibration mode or the first monitoring mode, and a third time interval during which the primary radar MMIC is set in the first radar operation mode, the second time interval being between the first time interval and the third time interval.

24. A radar monolithic microwave integrated circuit (MMIC), comprising:
a control logic configured to set the radar MMIC in a plurality of operation modes, including a radar operation mode and at least one of a monitoring mode or a calibration mode;
a local oscillator (LO) input terminal configured to receive a first LO signal from outside of the radar MMIC during a mode in which LO distribution of the first LO signal is enabled;
a clock input terminal configured to receive a system clock signal during the plurality of operation modes;
an LO generation circuit configured to generate a second LO signal based on the system clock signal;
an enabling-disabling circuit configured to receive a control signal indicating whether the LO distribution of the first LO signal is enabled or disabled, enable the second LO signal based on the control signal indicating that the LO distribution of the first LO signal is disabled, and disable the second LO signal based on the control signal indicating that the LO distribution of the first LO signal is enabled; and
a combiner circuit configured to receive the first LO signal or the second LO signal based on the LO distribution being enabled or disabled, respectively; and
a radar circuit coupled to the combiner circuit and configured to receive either the first LO signal or the second LO signal,
wherein the LO distribution of the first LO signal is enabled during the radar operation mode of the radar MMIC and disabled during at least one of the calibration mode or the monitoring mode of the radar MMIC.

25. The radar MMIC of claim 24, wherein the enabling-disabling circuit is configured to enable the LO generation circuit based on the control signal indicating that the LO distribution of the first LO signal is disabled, and disable the LO generation circuit based on the control signal indicating that the LO distribution of the first LO signal is enabled.
